(19) United States
(12) Patent Application Publication
(10) Pub. No.: US 2026/0137197 A1
(43) Pub. Date: May 21, 2026

(54) Artificial Intelligence-Powered Hair Style Recommendation and Visualization System

(71) Applicant: Rachel Graefe, Lake Mary, FL (US)

(72) Inventor: Rachel Graefe, Lake Mary, FL (US)

(21) Appl. No.: 19/245,892

(22) Filed: Jun. 23, 2025

Related U.S. Application Data
(60) Provisional application No. 63/720,784, filed on Nov. 15, 2024.

(51) Int. Cl. A45D 44/00; G06Q 30/0601; G06T 11/60

(52) U.S. Cl. CPC A45D 44/005; G06Q 30/0631; G06Q 30/0643; G06T 11/60; A45D 2044/007

(57) ABSTRACT

The present invention is a personalized hair color recommendation system to provide tailored hair color suggestions without professional assistance (i.e., human interaction). The system includes a mobile application which receives an image(s) of a user wherein the image(s) includes hair. The application may also receive an inspirational image. The system includes an artificial intelligence (AI) engine to analyze the user's current (and historical) hair status, color, undertones, texture, and the inspirational image. A recommendation engine determines personalized hair colors based on the analysis of user-provided intake responses, user preferences, and skin tone compatibility. The mobile application presents the recommendations with real-time augmented reality (AR) visualization and displays purchasable products related to the suggested hair color. The system enables users to select and purchase products via an integrated e-commerce module. The system further provides guidance or instructions for color application.

### CROSS-REFERENCE TO RELATED APPLICATION

The present application claims priority to, and the benefit of, U.S. Provisional Application No. 63/720,784 which was filed on Nov. 15, 2024, and is incorporated herein by reference in its entirety.

### FIELD OF THE INVENTION

The present invention generally relates to personalized hair color recommendation systems. More specifically, the invention relates to an AI-powered system designed to provide tailored hair color recommendations and visualization for users without the need for professional assistance. The invention includes a mobile application to upload images depicting the user's current hair and an inspirational image showcasing a desired hair color. The system includes an artificial intelligence (AI) engine configured to analyze the user's hair color, undertones, and texture, and to extract dominant tones from the inspirational image. The mobile application provides augmented reality (AR) functionality to visualize recommended colors in real-time and includes an integrated e-commerce module for purchasing related products. Accordingly, the present disclosure makes specific reference thereto. Nonetheless, it is to be appreciated that aspects of the present invention are also equally applicable to other like applications, devices, and methods of manufacture.

### BACKGROUND

By way of background, hair coloring is popular among individuals to enhance their appearance and experiment with new styles. Individuals often enjoy changing their hair color to reflect their personality, follow trends, or simply refresh their look. However, the process of selecting the right hair color is challenging. Individuals generally have the idea about compatibility of the color only after the coloring process is complete. Furthermore, hair color experimentation often involves repeated trials, which can lead to excessive chemical exposure, causing significant damage to the hair's health and texture over time. Each coloring attempt is time consuming, costly, and requires time for preparation, application, and post-coloring maintenance. Removing or correcting an unsatisfactory hair color is even more time intensive.

Traditional methods, such as color swatches or filters, do not provide realistic previews of the final result. Many applications and tools lack personalization and fail to account for factors like current hair health, color, and undertones. Even after deciding on a color, individuals face challenges in selecting the appropriate products that match their needs and preferences. Misusing or choosing incompatible products can lead to further dissatisfaction and damage. Individuals desire a comprehensive system that not only provides realistic visualizations of potential hair colors but also offers personalized recommendations, product suggestions, and guidance for safe application and maintenance.

Therefore, there exists a long-felt need in the art for a personalized hair color recommendation system that eliminates the uncertainty and dissatisfaction associated with traditional hair coloring methods. There is a long-felt need for a solution that enables individuals to visualize potential hair colors on their own hair before application. Additionally, there is a long-felt need for a system that considers individual hair characteristics, such as current color, texture, and health, as well as skin tone and undertones. Further, there is a long-felt need for a system that reduces the risk of hair damage caused by frequent trial-and-error experiments with unsuitable hair colors. Furthermore, there is a long-felt need for an integrated solution that recommends personalized hair colors and provides direct access to suitable products. Finally, there is a long-felt need for a user-friendly platform that simplifies the hair color transformation process without requiring professional expertise.

The subject matter disclosed and claimed herein, in one embodiment, comprises a personalized hair color recommendation system. The system includes a mobile application installed on an electronic device that enables users to upload images depicting their current hair and, optionally, an inspirational image showcasing a desired hair color. The system includes an artificial intelligence (AI) engine for analyzing uploaded images to identify the user's current (and historical) hair status, color, undertones, and texture. The AI engine evaluates inspirational images to extract dominant and secondary tones. A recommendation engine generates personalized hair color suggestions based on the analysis and user-specific attributes, such as skin tone, preferences, and hair health. The mobile application also provides augmented reality (AR) functionality to visualize recommended hair colors in real-time and includes an e-commerce integration module for purchasing relevant products.

In this manner, the personalized hair color recommendation system of the present invention accomplishes all of the foregoing objectives and provides a practical, user-centric solution for at-home hair color transformations. The system provides accurate and personalized recommendations considering individual attributes and preferences. The integration of real-time AR visualizations enables users to see how the recommended color will look on their own hair before applying the recommended color. Furthermore, the system includes an e-commerce module which enables purchase of recommended products.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a personalized hair color recommendation system. The system comprises a mobile application installed on an electronic device, a server system is communicatively coupled with the mobile application via a communication channel, the server system comprises an artificial intelligence (AI) engine configured to analyze an uploaded image to detect the user's current (and historical) hair status, color, hair undertones, and hair texture, evaluate an optional inspirational image uploaded by the user to extract dominant and secondary hair tones, a recommendation engine is configured to select at least one personalized hair color recommendation based on the analysis by the AI engine and user preferences stored in a user profile database, an e-commerce integration API module to display purchasable hair color products associated with the recommended hair color and enable in-app purchases, and a file storage system configured to securely store user-uploaded images.

In another aspect, a non-transitory computer-readable medium storing instructions that, when executed by a processor of an electronic device, cause the device to perform operations for recommending a personalized hair color is disclosed. The operations comprise providing a user interface for uploading at least one image of the user depicting the user's hair, transmitting the uploaded image to a server system for analysis, receiving, from the server system, data including, a recommended hair color selected based on the analysis of the user's hair attributes and an optional inspirational image, augmented reality display for applying the recommended color to the user's uploaded image, rendering the AR visualization of the recommended hair color on the uploaded image, and displaying purchasable hair color products associated with the recommended color.

In another embodiment, a method for recommending a personalized hair color using a system comprising a mobile application and a server system is described. The method includes the steps of receiving, via the mobile application, a first image of the user depicting the user's hair, receiving a second inspirational image uploaded by the user, depicting a desired hair color, analyzing, by an artificial intelligence (AI) engine in the server system, the first image to detect the user's current (and historical) hair status, color, undertones, and texture, the second image to extract dominant and secondary tones, determining, by a recommendation engine, at least one matched hair color, presenting the at least one matched hair color recommendation on the mobile application, including a real-time AR visualization of the recommended color applied to the user's uploaded image, and purchasable hair products associated with the recommended color.

In one embodiment, the AI engine includes a deep learning model trained to consider variations in lighting and shadows in the user-uploaded image, and an algorithm for detecting the user's skin tone and undertones, wherein the hair color recommendation is adjusted to align with the detected skin tone for improved aesthetic compatibility.

In yet another aspect, the system provides a step-by-step set of DIY instructions for applying the recommended hair color at home.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters

refer to similar parts throughout the different views, and in which:

FIG. 1 illustrates a schematic view of personalized styling recommendation system of the present invention in accordance with the disclosed architecture;

FIG. 2 illustrates a flow chart depicting a process of recommending a hair color to a user in accordance with one embodiment of the present invention;

FIG. 3 illustrates a flow chart depicting a process of enabling users to purchase different hair products using the hair color recommendations system of the present invention in accordance with the disclosed architecture; and

FIG. 4 illustrates a flow chart depicting a process of selection of one or more matched hair colors by the hair color matching system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a personalized hair color recommendation system that eliminates the uncertainty and dissatisfaction associated with traditional hair coloring methods. There is a long-felt need for a solution that enables individuals to visualize potential hair colors on their own hair before application. Additionally, there is a long-felt need for a system that considers individual hair characteristics, such as current color, texture, and health, as well as skin tone and undertones. Further, there is a long-felt need for a system that reduces the risk of hair damage caused by frequent trial-and-error experiments with unsuitable hair colors. Furthermore, there is a long-felt need for an integrated solution that recommends personalized hair colors and provides direct access to suitable products. Finally, there is a long-felt need for a user-friendly platform that simplifies the hair color transformation process without requiring professional expertise.

The present invention, in one exemplary embodiment, is a method for recommending a personalized hair color using a system comprising a mobile application and a server system. The method includes the steps of receiving, via the mobile application, a first image of the user depicting the user's hair, receiving a second inspirational image uploaded by the user, depicting a desired hair color and style, analyzing, by an artificial intelligence (AI) engine in the server system, the first image to detect the user's current (and historical) hair status, color, undertones, and texture, the second image to extract dominant and secondary tones, determining, by a recommendation engine, at least one matched hair color, presenting the at least one matched hair color recommendation on the mobile application, including a real-time AR visualization of the recommended color applied to the user's uploaded image, and purchasable hair products associated with the recommended color. The system will offer virtual appointments for hair stylists to give advice, give product suggestions, help correct mistakes, etc. These virtual appointments will be offered through a private chat room between the hair stylist and users utilizing a camera and microphone. Users will then pay for these services through the system.

One exemplary AI engine or AI virtual hair assistant (i.e., ‘Chroma’) involves guiding a user through hair color selection by responding to user inputs from structured prompt logic. The virtual hair assistant provides step-by-step instructions, simulates the tone and logic of a licensed stylist, and can be monetized per session or integrated into a subscription. The virtual hair assistant uses user intake flags (i.e., box hair dye, perms, damage, et. al.) to dynamically assemble instructions and product paths. Intake flags or flag-based routing includes flag-based decision trees (i.e., if hair dye is present, then a color remover is recommended), logic branching based on intake form responses, and/or conditional output logic (i.e., not just passive data collection). The virtual hair assistant includes dynamic prompt assembly that assembles guidance based on multiple inputs (i.e., photo data, intake flags, inspiration images, and prior session information). The virtual hair assistant: guides users through personalized color selection and safety recommendations; uses structured prompt logic to simulate a licensed stylist's expertise; monetizes via pay per session or subscription; and offers step-by-step guidance, product selection, and decision support based on intake and photo data. The flag-based routing logic includes the intake form generating flag-based triggers (i.e., hair dye present, permed hair, over processed color, et. al.). The aforementioned flags determine which logic branches are activated. Output is routed through conditional decision trees. The system mimics an in-person consultation process, including safety branching logic. The dynamic prompt assembly is assembled in real time based on user uploaded images, intake flags, desired hair color goals, safety rules, and/or previously captured responses.

Reference will now be made in detail to the present preferred embodiments of the invention, examples of which are illustrated in the accompanying drawings. Wherever possible, the same reference numerals are used in the drawings and the description to refer to the same or like parts.

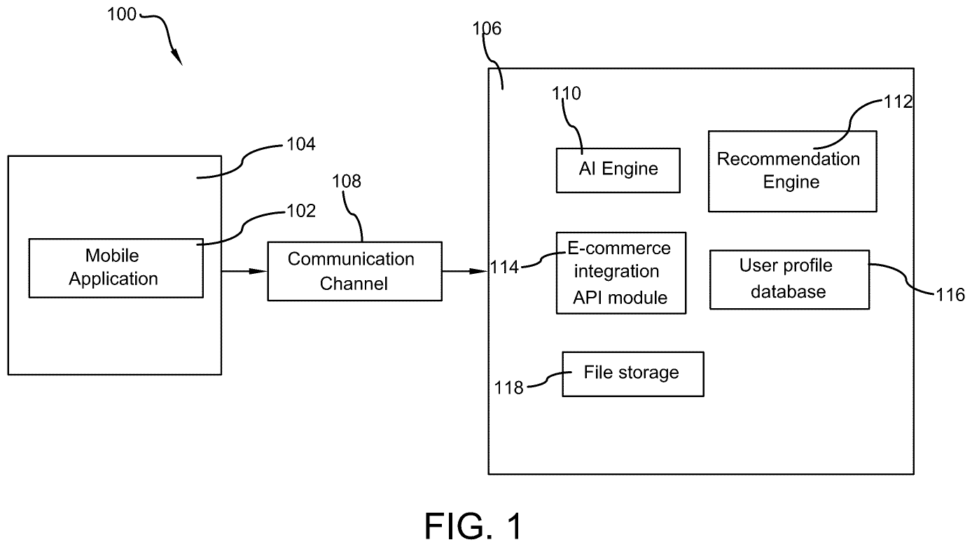

Referring initially to the drawings, FIG. 1 illustrates a schematic view of personalized styling recommendation system of the present invention in accordance with the disclosed architecture. The personalized styling recommendation system 100 of the present invention is designed to offer personalized recommendations for hair color to users without the need for professional help. More specifically, the system 100 includes a mobile application 102 which is configured to enable a user to upload their images for recommendation of best hair color match for user. The application 102 enables the user to use the input functionality of an electronic device 104 in which the application 102 is installed. The application 102 is adapted to provide different user interfaces for enabling users to upload their images and receive visualization of matched hair colors.

The application 102 is configured to connect to a server system 106 via a communication channel 108 for accessing different functionalities provided by the system 100 and stored in the server system 106. It should be noted that some of the features can be provided locally in the mobile application 102 and advanced functionalities such as analysis of the uploaded image and determination of the best hair color match is performed in the server system 106. In some embodiments, all the features and processes of the system 100 as described later in the disclosure can also be locally accessed by a user from the application 102 without requiring an active connection with the server system 106.

The server system 106 includes an artificial intelligence (AI) engine 110 which is configured to evaluate the photos uploaded by users using the application 102. The AI engine 110 is designed to autonomously identify hair color, hair undertones, and hair texture by analyzing the images (i.e., hair analyzer). The AI engine 110 further includes a skin tone and a skin color analyzer (i.e., skin analyzer) compatible deep learning models and algorithms for analyzing the hair color, the hair undertones, and the hair texture from images (i.e., uploaded photos) in conjunction with the skin analyzer. A recommendation engine 112 is designed to select the best hair colors (i.e., a second hair color or another hair color) based on analysis of images by the AI engine 110. The recommendation engine 112 is trained using user preferences (based on profile of user), feedback of different users, and hair condition in the uploaded image.

One advantage of the system 100 is that the application 102 can show or list the products required by a user for hair color transformation to, for example, the second hair color. An E-commerce integration API module 114 is included in the system 100 to enable users of the system 100 to connect to retailers and product suppliers of displayed hair products. Users can add products to their cart within the application 102 and order the products directly from partnered retailers or brands. The E-commerce integration API module 114 also provides real-time updates for product availability and prices on different partner retailers.

A user profile database 116 stores user profile data of registered users of the system 100 and information includes at least their previously selected hair colors, their preferences such as excluded colors, excluded companies and more. The database 116 can be any scalable relational or non-relational database. A file storage 118 is included in the server system 106 for securely storing user-uploaded images and the recommended hair color images (i.e., the second or another hair color). The file storage 118 is used for optimized file compression and storage for faster retrieval.

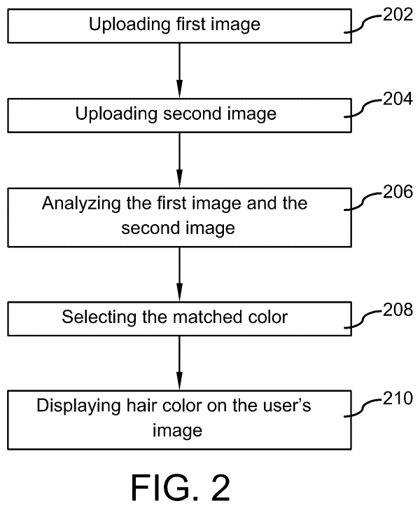

FIG. 2 illustrates a flow chart depicting a process of recommending a hair color to a user in accordance with one embodiment of the present invention. Initially, a user uploads a clear front image (first image) thereof using the application 102 (Step 202). The front image should contain the hair with focus on hair color. In the present embodiment, the user then uploads a second image which can be of any other user such as a celebrity, a model, or of the user in some other hair color analyzer (Step 204). The second image may be used as a reference by the system 100 for recommending a matched hair color (i.e., another second color) to the user. In some embodiments, the user may not upload the second image and enable the system 100 to use only the first image for recommending the matched hair color.

In the next step, the system 100 uses the artificial intelligence (AI) engine 110 to evaluate both the first image and the second image to identify the user's current (and historical) hair status, color, undertones, and texture and analyzing the inspirational image for the reference color tone and style (Step 206). Then, the system 100 using the recommendation engine 112 chooses at least one matched hair color (i.e., at least another hair color) from a list of stored hair colors for recommendation to the user (Step 208). It should be noted that the AI engine 110 and the recommendation engine 112 do not use preset filters and therefore, provide a personalized hair color. In some embodiments, the application 102 can display two or more matched hair color options to the user. Finally, the application 102 displays an augmented reality display for rendering the recommended hair color on the user's uploaded image in real-time (Step 210) such as in the form of an avatar, a 3D image, or the updated uploaded image.

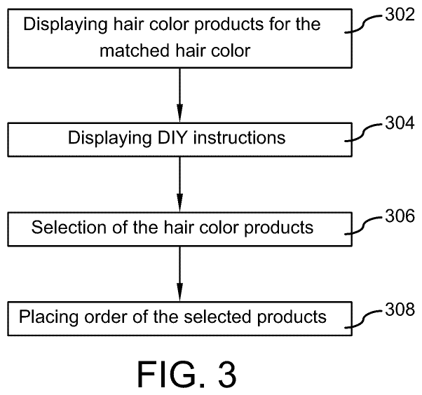

FIG. 3 illustrates a flow chart depicting a process of enabling users to purchase different hair products using the hair color recommendations system of the present invention in accordance with the disclosed architecture. When a matched hair color is selected by a user in the application 102, then, different hair color products including but not limited to hair dye kits, hair toners, and hair protective treatments related to the matched hair color are displayed to the user (Step 302). The hair products can be from different e-commerce websites which are registered partners of the system 100. Do-it-yourself (DIY) instructions set is also displayed by the application 102 for the matched hair color analyzer (Step 304). Then, selection of one or more hair products is received from the user (Step 306) and upon a successful payment, the products are ordered on different ecommerce websites from the application 102 (Step 308).

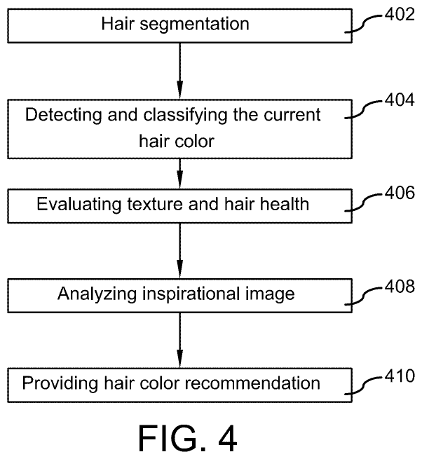

FIG. 4 illustrates a flow chart depicting a process of selection of one or more matched hair colors by the hair color matching system in accordance with the disclosed architecture. On the uploaded image of a user, the AI engine 110 performs hair segmentation to isolate the hair region using the computer vision models (Step 402). Then, the deep learning algorithms detect and classify the current (and historical) hair status, color of the user (Step 404). The algorithms consider variations in hair color due to lighting and shadows. Thereafter, the engine 110 evaluates the texture and hair health of hair from the image (Step 406). When the inspirational image is uploaded as well by the user, then, the dominant and secondary tones from the inspirational image are extracted (Step 408) and a hair color recommendation is provided upon matching the inspirational image features to the user's hair type and condition (Step 410). It should be noted that skin tone of the user is also detected from their uploaded image to align the hair color recommendation with the user's skin tone and undertone.

The present invention evaluates unique combination of hair color, condition, and inspiration based on the images to provide a customized recommendation to the users. The system evaluates the user's hair health and natural base color before recommending hair color products, avoiding suggestions that are unrealistic or damaging. The application 102 may provide live chat for assistance with color application or product purchases. Further, the application 102 enables users to upload their before-and-after transformations images to different social media platforms directly from the application 102.

One embodiment of the AI virtual hair assistant guides a user through hair color selection by responding to user inputs from structured prompt logic. The virtual hair assistant provides step-by-step instructions, simulates the tone and logic of a licensed stylist, and monetizes each session or is integrated into a subscription. The virtual hair assistant uses user intake flags (i.e., box hair dye, perms, damage, et. al.) to dynamically assemble instructions and product paths. Intake flags or flag-based routing includes flag-based decision trees (i.e., if hair dye is present, then a color remover is recommended), logic branching based on intake form responses, and/or conditional output logic (i.e., not just passive data collection). The virtual hair assistant includes dynamic prompt assembly that assembles guidance based on multiple inputs (i.e., photo data, intake flags, inspiration images, and prior session information). The virtual hair assistant guides users through personalized color selection and safety recommendations; uses structured prompt logic to simulate a licensed stylist's expertise; monetizes a pay per session or subscription service; and offers step-by-step guidance, product selection, and decision support based on intake and photo data. The flag-based routing logic includes the intake form generating flag-based triggers (i.e., hair dye present, permed hair, over processed color, et. al.). The aforementioned flags determine which logic branches are activated. Output is routed through conditional decision trees. The system mimics an in-person consultation process, including safety branching logic. The dynamic prompt assembly is assembled in real time based on user uploaded images, intake flags, desired hair color goals, safety rules, and/or previously captured responses.

Another embodiment or method of the virtual or AI hair assistant guides a user through hair color selection mobile app by responding to user-provided intake responses, inputs, or intake triggers. The method includes receiving user-provided intake responses selected from the group consisting of current hair condition, prior chemical treatment history, desired color goal, an uploaded selfie (i.e., user-provided) image, an uploaded inspiration image; analyzing the intake responses using a rule-based or zone-based decision engine trained on cosmetology principles (i.e., licensed cosmetology logic); generating a personalized hair color recommendation with application guidance; and overlaying the recommended shade on the user-provided image using image segmentation. Intake triggers further include prior use(s), history, or hair status flags for gray coverage, past use of henna based dye, past use of bleach or highlighted hair, past use of box hair dye, past use of multiple fashion colors, transition from blond to dark hair, removal or correction of vivid colors, lighten red or copper tone to blond or ash color, visible lines of demarcation or banding, adding highlights, adding root smudge or shadow root, applying pastel or vivid colors, over-processed hair, chemically relaxed hair, and relaxed or permed hair. Logic for the zone-based decisions, product recommendations, and/or application instructions/guidance, based on the answers or responses to the intake triggers, include specific instructions for hair transformation zones including hair roots, hair midshafts, and hair ends; and, safety rules to prevent overlapping or overprocessing. Safety rules or decisions include changing a first color to a second color involving transitions triggering multi-phase recommendations, and warnings against bleach use on chemically treated hair (i.e., chemical restrictions). Product recommendations and filtering involve the intake triggers including hair color goals, hair and color history, safety risks, and required prep steps (i.e., pre-bleach hair transformation steps). The product recommendations direct the user to product fulfillment pathways and/or website links tied to the user's hair goals and products. In addition, the user can be directed to a live stylist consultation when the virtual hair assistant teaches hair transformations that are close to the edge of safe guidance, conflict with safety rules, and/or to confirm products and application instructions. The hair assistant mobile app provides to the live stylist the responses or answers to the intake triggers that were supplied by the user. The consultation is scheduled with the live stylist and the user. The consultation is scheduled, for example, via a Zoom call. The hair assistant mobile app records the consultation.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “AI-powered personalized hair color recommendation system”, “smart hair color matching system”, “personalized styling recommendation system”, “hair color matching system”, and “system” are interchangeable and refer to the AI-powered personalized hair color recommendation and visualization system 100 of the present invention.

Notwithstanding the forgoing, the AI-powered personalized hair color recommendation and visualization system 100 of the present invention can be of any suitable size and configuration as is known in the art without affecting the overall concept of the invention, provided that it accomplishes the above stated objectives. One of ordinary skill in the art will appreciate that the AI-powered personalized hair color recommendation and visualization system 100 as shown in the FIGS. are for illustrative purposes only, and that many other sizes and shapes of the AI-powered personalized hair color recommendation and visualization system 100 are well within the scope of the present disclosure. Although the dimensions of the AI-powered personalized hair color recommendation and visualization system 100 are important design parameters for user convenience, the AI-powered personalized hair color recommendation and visualization system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A personalized styling recommendation system comprising:
a mobile application for uploading images;
an electronic device;
a server system;
a communication channel;
a hair analyzer;
a skin analyzer;
an Artificial Intelligence (AI) engine;
wherein said mobile application connected to said server system with said communication channel;
wherein said server system having said artificial intelligence engine;
wherein said artificial intelligence engine evaluates uploaded images to said mobile application;
wherein said AI engine having said hair analyzer for autonomously identifying a first hair color, a first hair undertone, and a first hair texture of said uploaded images;
wherein said AI engine having said skin analyzer for autonomously identifying a skin tone and a skin color of said uploaded images; and
further wherein said AI engine having a recommendation engine for recommending a second hair color, a second hair undertone, and a second hair texture based on said first hair color, said first hair undertone, and said first hair texture.

2. The personalized styling recommendation system of claim 1, wherein said AI engine having said recommendation engine for recommending said second hair color, said second hair undertone, and said second hair texture based on said skin tone and said skin color.

3. The personalized styling recommendation system of claim 2, wherein said recommendation engine recommending said second hair color based on another criteria selected from the group consisting of a user preference, a feedback of different users, and a hair condition in said uploaded images.

4. The personalized styling recommendation system of claim 3, wherein said mobile application associates said second hair color to a list of products needed for transforming from said first hair color to said second hair color.

5. The personalized styling recommendation system of claim 4 further comprising an E-commerce integration API module, wherein said E-commerce integration API module connects said list of products to a retail supplier of said list of products.

6. The personalized styling recommendation system of claim 5, wherein said retail supplier is a partnered retail supplier with said mobile application.

7. The personalized styling recommendation system of claim 4, wherein said list of products is selected from the group consisting of a hair dye kit, a hair toner, and a hair protective treatment.

8. The personalized styling recommendation system of claim 3 further comprising a user profile database, wherein said user profile database stores information of a registered user selected from the group consisting of said user preference, a previously selected hair color, and an excluded hair color.

9. The personalized styling recommendation system of claim 8, wherein said recommendation engine recommending said second hair color based on other uploaded images of another individual.

10. The personalized styling recommendation system of claim 8, wherein said mobile application augments images of said uploaded images with said second hair color and displays said augmented images on said electronic device.

11. A method of recommending a personalized hair style, the method comprising the steps of:
providing a mobile application for uploading images, an electronic device, a server system, a communication channel, a hair analyzer, a skin analyzer, and an Artificial Intelligence (AI) engine;
connecting said mobile application to said server system with said communication channel, wherein said server system having said artificial intelligence engine;
uploading images to said mobile application;
evaluating said uploaded images with said AI engine, wherein said AI engine having said hair analyzer for autonomously identifying a first hair color, a first hair undertone, and a first hair texture of said uploaded images, further wherein said AI engine having said skin analyzer for autonomously identifying a skin tone and a skin color of said uploaded images; and
recommending a second hair color, a second hair undertone, and a second hair texture based on said first hair color, said first hair undertone, and said first hair texture with a recommendation engine of said AI engine.

12. The method of recommending a personalized hair style of claim 11, wherein said AI engine having said recommendation engine for recommending said second hair color, said second hair undertone, and said second hair texture based on said skin tone and said skin color.

13. The method of recommending a personalized hair style of claim 12, wherein said recommendation engine recommending said second hair color based on another criteria selected from the group consisting of a user preference, a feedback of different users, and a hair condition in said uploaded images.

14. The method of recommending a personalized hair style of claim 13, wherein said mobile application associates said second hair color to a list of products needed for transforming from said first hair color to said second hair color.

15. The method of recommending a personalized hair style of claim 14 further comprising an E-commerce integration API module, wherein said E-commerce integration API module connects said list of products to a retail supplier of said list of products.

16. The method of recommending a personalized hair style of claim 15, wherein said retail supplier is a partnered retail supplier with said mobile application.

17. The method of recommending a personalized hair style of claim 16 further comprising a user profile database, wherein said user profile database stores information of a registered user selected from the group consisting of said user preference, a previously selected hair color, and an excluded hair color.

18. The method of recommending a personalized hair style of claim 17, wherein said recommendation engine recommending said second hair color based on other uploaded images of another individual.

19. The method of recommending a personalized hair style of claim 17, wherein said mobile application augments images of said uploaded images with said second hair color and displays said augmented images on said electronic device.

20. A method of recommending a personalized hair color, the method comprising the steps of:
providing a mobile application for receiving user-provided intake responses, an electronic device, a server system, a communication channel, and an Artificial Intelligence (AI) engine;
connecting said mobile application to said server system with said communication channel, wherein said server system having said artificial intelligence engine;
uploading said user-provided intake responses to said mobile application, wherein said user-provided intake responses selected from the hair status group consisting of one or more of gray coverage, past use of henna based dye, past use of bleach, past use of highlights, past use of box hair dye, past use of multiple fashion colors, transition from blond to dark hair, removal of vivid colors, correction of vivid colors, lighten red tone to blond color, lighten copper tone to ash color, visible lines of demarcation, adding highlights, adding root smudge, adding shadow root, applying pastel colors, applying vivid colors, over-processed hair, chemically relaxed hair, and chemically permed hair;
analyzing said user-provided intake responses using a rule-based decision engine including cosmetology principles;
generating a hair color recommendation including product recommendations and application guidance;
overlaying said hair color recommendation on a user-provided image; and
wherein said product recommendations include considerations selected from the group consisting of hair color goals, hair color history, safety risks, and hair transformation steps.
